(19) United States
(12) Patent Application Publication
(10) Pub. No.: US 2026/0051749 A1
(43) Pub. Date: Feb. 19, 2026

(54) POWER SUPPLY SYSTEM AND CHARGING SYSTEM

(71) Applicant: TOYOTA JIDOSHA KABUSHIKI KAISHA, Toyota-shi (JP)

(72) Inventor: Jinwoo KIM, Toyota-shi (JP)

(73) Assignee: TOYOTA JIDOSHA KABUSHIKI KAISHA, Toyota-shi (JP)

(21) Appl. No.: 19/069,782

(22) Filed: Mar. 4, 2025

(30) Foreign Application Priority Data
Aug. 19, 2024 (JP) 2024-137865

(51) Int. Cl. H02J 7/00

(52) U.S. Cl. CPC H02J 7/0013; H02J 7/00716; H02J 2207/20

(57) ABSTRACT

During parallel charging, a control device sets a minimum value of first allowable input power of a first battery and second allowable input power of a second battery as common requested power of the first and second batteries, sets total requested power based on the common requested power, requests charging equipment for the total requested power or a total requested current that is based on the total requested power, and controls first and second inverters using the common requested power or a current command for the second battery that is based on the common requested power. The control device requests the charging equipment to stop the parallel charging when a difference between the common requested power and charging power of the second battery or between the current command for the second battery and a charging current of the second battery is equal to or larger than a predetermined value.

### CROSS-REFERENCE TO RELATED APPLICATION

This application claims priority to Japanese Patent Application No. 2024-137865 filed on Aug. 19, 2024. The disclosure of the above-identified application, including the specification, drawings, and claims, is incorporated by reference herein in its entirety.

### BACKGROUND

### 1. Technical Field

The present disclosure relates to a power supply system and a charging system.

### 2. Description of Related Art

Hitherto, there has been proposed a power supply system including a power storage device and an inlet (see, for example, Japanese Unexamined Patent Application Publication No. 2019-118221 (JP 2019-118221 A)). The power storage device includes first and second batteries and a switching relay capable of switching a first state in which the first and second batteries are connected in series and a second state in which the first and second batteries are connected in parallel. The inlet is connected to a positive line and a negative line that connect the power storage device and a PCU that drives a motor.

### SUMMARY

In recent years, there has been devised a power supply system that includes first and second batteries and a charging connector, and that is capable of performing parallel charging for charging the first and second batteries via first and second charging paths using electric power from charging equipment connected to the charging connector. In such a power supply system, when the second charging path is interrupted during the parallel charging, the electric power from the charging equipment concentrates on the first charging path, and an overcurrent flows through a component of the first charging path, such as a switching relay.

A primary object of a power supply system and a charging system of the present disclosure is to prevent an overcurrent from flowing through a component of a first charging path as a path of a current for charging a first battery.

The power supply system of the present disclosure adopts the following measures in order to achieve the above primary object.

The power supply system of the present disclosure is a power supply system including a first battery and a second battery. The power supply system includes:
a motor including a three-phase coil;
a first inverter connected to the first battery via a first positive line and a negative line and connected to one end of the three-phase coil;
a second inverter connected to the second battery via a second positive line and the negative line and connected to the other end of the three-phase coil;
a charging connector connected to the first positive line and the negative line and electrically connectable to charging equipment; and
a control device configured to, during parallel charging for charging the first battery and the second battery using electric power from the charging equipment, set a minimum value of each of first allowable input power of the first battery and second allowable input power of the second battery as common requested power of the first battery and the second battery, set total requested power based on the common requested power, request the charging equipment for the total requested power or a total requested current that is based on the total requested power, and control the first inverter and the second inverter using the common requested power or a current command for the second battery that is based on the common requested power.

The control device is configured to request the charging equipment to stop the parallel charging when a difference between the common requested power and charging power of the second battery or a difference between the current command for the second battery and a charging current of the second battery is equal to or larger than a predetermined value.

The power supply system of the present disclosure is configured to, during the parallel charging for charging the first battery and the second battery using the electric power from the charging equipment, set the minimum value of each of the first allowable input power of the first battery and the second allowable input power of the second battery as the common requested power of the first battery and the second battery, set the total requested power based on the common requested power, request the charging equipment for the total requested power or the total requested current that is based on the total requested power, and control the first inverter and the second inverter using the common requested power or the current command for the second battery that is based on the common requested power. Further, the charging equipment is requested to stop the parallel charging when the difference between the common requested power and the charging power of the second battery or the difference between the current command for the second battery and the charging current of the second battery is equal to or larger than the predetermined value. As a result, it is possible to prevent an overcurrent from flowing through the component of the first charging path as the path of the current for charging the first battery during the parallel charging. The predetermined value is a threshold value for determining whether the second charging path as the path of the current for charging the second battery is interrupted.

In the power supply system of the present disclosure, the control device may be configured to, when stopping the parallel charging, set the total requested power or the total requested current to a value of zero.

In this way, the parallel charging can be stopped more appropriately.

In the power supply system of the present disclosure, the control device may be configured to set first corrected requested power of the first battery by performing feedback correction based on a difference between the common requested power and charging power of the first battery, set second corrected requested power of the second battery by performing feedback correction based on the difference between the common requested power and the charging power of the second battery, and set a sum of the first corrected requested power and the second corrected requested power as the total requested power.

In this way, when the feedback correction based on the difference between the common requested power and the charging power of the first battery is performed during the parallel charging, it is possible to prevent an overcurrent from flowing through the component of the first charging path.

In the power supply system of the present disclosure, the control device may be configured to set a double of the common requested power as the total requested power.

In this way, the total requested power can be set more appropriately.

The charging system of the present disclosure includes:
the power supply system of the present disclosure in any one of the aspects described above, that is, the power supply system basically including:
   the first inverter connected to the first battery via the first positive line and the negative line and connected to one end of the three-phase coil;
   the second inverter connected to the second battery via the second positive line and the negative line and connected to the other end of the three-phase coil;
   the charging connector connected to the first positive line and the negative line and electrically connectable to the charging equipment; and
   the control device configured to, during the parallel charging for charging the first battery and the second battery using the electric power from the charging equipment, set the minimum value of each of the first allowable input power of the first battery and the second allowable input power of the second battery as the common requested power of the first battery and the second battery, set the total requested power based on the common requested power, request the charging equipment for the total requested power or the total requested current that is based on the total requested power, and control the first inverter and the second inverter using the common requested power or the current command for the second battery that is based on the common requested power, in which
   the control device is configured to request the charging equipment to stop the parallel charging when the difference between the common requested power and the charging power of the second battery or the difference between the current command for the second battery and the charging current of the second battery is equal to or larger than the predetermined value; and
the charging equipment.

The charging equipment includes a power supply device configured to supply electric power from an external power supply to the power supply system, and a power supply control device configured to control the power supply device to supply the total requested power or the total requested current to the power supply system.

Since the charging system of the present disclosure includes the power supply system of the present disclosure in any one of the aspects described above, the charging system has effects similar to those of the power supply system of the present disclosure, for example, the effect of preventing an overcurrent from flowing through the component of the first charging path as the path of the current for charging the first battery during the parallel charging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a charging system 1 including a power supply system 10 and a charging station 80 according to an embodiment of the present disclosure;

FIG. 2 is an explanatory diagram illustrating a current flow in parallel charging;

FIG. 3 is a flow chart illustrating an exemplary process routine executed by the system ECU 50; and

FIG. 4 is an explanatory diagram illustrating a current flow when a second charging path indicated by a thick broken line with an arrow in FIG. 2 is interrupted for some reason in parallel charging.

### DETAILED DESCRIPTION OF EMBODIMENTS

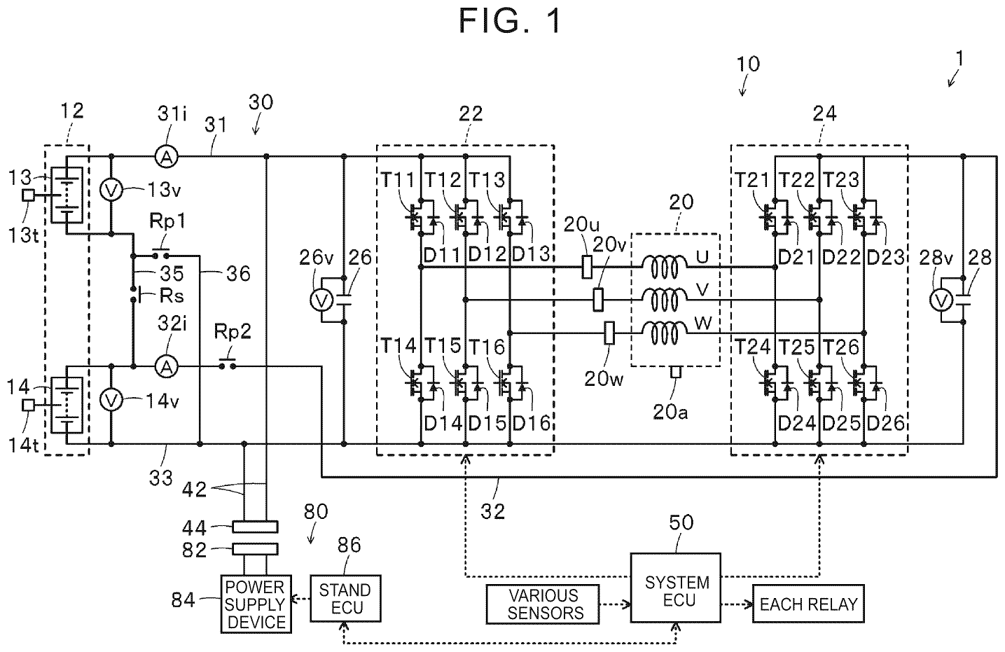

Embodiments for carrying out the present disclosure will be described with reference to the drawings. FIG. 1 is a schematic configuration diagram of a charging system 1 including a power supply system 10 and a charging station (charging equipment) 80 according to an embodiment of the present disclosure. The charging system 1 includes a power supply system 10 and a charging station 80.

The power supply system 10 is mounted on a battery electric vehicle or a hybrid electric vehicle. The power supply system 10 includes a battery 12, a motor 20, a first inverter 22, a second inverter 24, a switching circuit 30, a charging circuit 40, and a system electronic control unit 50 as a control device. The electronic control unit 50 for a system is hereinafter referred to as a “system ECU”. The power supply system 10 is capable of charging the battery 12 using electric power from a charging station 80 provided at a home, a charging station, or the like.

The battery 12 includes a first battery 13 and a second battery 14 as a first battery and a second battery. The first battery 13 and the second battery 14 are each configured as, for example, a lithium-ion secondary battery or a nickel-hydrogen secondary battery whose rated voltage is slightly lower than the first voltage Vs1 (for example, 400 V). In the embodiment, the first battery 13 and the second battery 14 have the same specifications. The positive electrode terminal of the first battery 13 is connected to the first positive line 31, and the negative electrode terminal of the second battery 14 is connected to the negative line 33. The negative electrode terminal of the first battery 13 is connected to the positive electrode terminal of the second battery 14 via the series line 35. A series-relay Rs is attached to the series-line 35. Therefore, the first battery 13 and the second battery 14 are connected in series to each other by turning on the series-relay Rs.

The motor 20 is configured as a three-phase AC motor having, for example, a rotor in which a permanent magnet is embedded in a rotor core, and a stator in which a three-phase (U-phase, V-phase, and W-phase) coil is wound around the stator core. The first inverter 22 includes six transistors T11 to T16 as switching elements, and six diodes D11 to D16 connected in parallel to each of the six transistors T11 to T16. The transistors T11 to T16 are arranged in pairs so as to be source-side and sink-side with respect to the first positive line 31 and the negative line 33, respectively. Each of the connecting points of the two transistors that form a pair of the transistors T11 to T16 is connected to one end of a three-phase (U-phase, V-phase, and W-phase) coil of the motor 20. A smoothing first capacitor 26 is connected to the first positive line 31 and the negative line 33. Like the first inverter 22, the second inverter 24 includes six transistors T21 to T26 as switching elements and six diodes D21 to D26. The transistors T21 to T26 are arranged in pairs so as to be source-side and sink-side with respect to the second positive line 32 and the negative line 33, respectively. Each of the connecting points of the two transistors that are the pair of the transistors T21 to T26 is connected to the other end of the three-phase (U-phase, V-phase, and W-phase) coil of the motor 20. A smoothing second capacitor 28 is connected to the second positive line 32 and the negative line 33. Hereinafter, the transistor T11 to 13, T21 to T23 of the first and second inverters 22 and 24 may be referred to as an “upper arm”, and the transistor T14 to T16, T24 to T26 may be referred to as a “lower arm”.

In addition to the first positive line 31, the second positive line 32, the negative line 33, the series line 35, and the series relay Rs, the switching circuit 30 includes a parallel line 36, a first parallel relay Rp1, and a second parallel relay Rp2. The parallel line 36 connects the negative electrode terminal of the first battery 13 and the negative line 33. The first parallel relay Rp1 is attached to the parallel line 36. The second parallel relay Rp2 is attached to the second positive line 32.

The charging circuit 40 includes a charging line 42 connected to the first positive line 31 and the negative line 33, and a charging connector 44 connected to the charging line 42. The charging connector 44 is configured to be connectable to the stand connector 82 of the charging station 80.

The system ECU 50 includes a CPU, a ROM, RAM, a flash memory, an input/output port, a microcomputer having a communication port, various driving circuits, and various logic IC. The system ECU 50 receives signals from various sensors. Examples of the various sensors include a voltage sensor 13v, a temperature sensor 13t, a voltage sensor 14v, and a temperature sensor 14t. The voltage sensor 13v detects a voltage Vb1 of the first battery 13. The temperature sensor 13t detects a temperature Tb1 of the first battery 13. The voltage sensor 14v detects a voltage Vb2 of the second battery 14. The temperature sensor 14t detects a temperature Tb2 of the second battery 14. Further, a rotational position sensor 20a, a current sensor 20u, 20v, 20w, a voltage sensor 26v, and a voltage sensor 28v are also included. The rotational position sensor 20a detects the rotational position of the rotor of the motor 20. The current sensor 20u, 20v, 20w detects a current Iu, Iv, Iw flowing in each phase (U-phase, V-phase, and W-phase) of the motor 20. The voltage sensor 26v detects the voltage VH of the first capacitor 26. The voltage sensor 28v detects the voltage VL of the second capacitor 28. Further, a current sensor 31i for detecting a current Ip1 flowing through the first positive line 31 and a current sensor 32i for detecting a current Ip2 flowing through the second positive line 32 are also exemplified. It should be noted that the series relay Rs may be in the off-state and the first parallel relay Rp1 and the second parallel relay Rp2 may be in the on-state. That is, the first battery 13 may be connected to the first positive line 31 and the negative line 33, and the second battery 14 may be connected to the second positive line 32 and the negative line 33. At this time, the current Ip1 flowing through the first positive line 31 is equal to the current flowing through the first battery 13, and the current Ip2 flowing through the second positive line 32 is equal to the current flowing through the second battery 14. Further, there is a case where the series relay Rs is in the ON state and the first parallel relay Rp1 and the second parallel relay Rp2 are in the OFF state. That is, the first battery 13 and the second battery 14 may be connected in series. At this time, the current Ip1 flowing through the first positive line 31 is equal to the current flowing through the first battery 13 and the second battery 14.

The system ECU 50 calculates the power storage ratio SOC1, SOC2, the open-circuit voltage OCV1, OCV2, and the allowable input power (first and second allowable input power) Win1, Win2 of the first battery 13 and the second battery 14. The power storage ratio SOC1, SOC2 is calculated, for example, based on the integrated value of the current Ip1 flowing through the first positive line 31 when the series relay Rs is in the off state and the first parallel relay Rp1 and the second parallel relay Rp2 are in the on state. Here, the current Ip1 is a current flowing through the first battery 13. The power storage ratio SOC1, SOC2 is calculated based on, for example, an integrated current Ip2 flowing through the second positive line 32. Here, the current Ip2 is a current flowing through the second battery 14. Further, the power storage ratio SOC1, SOC2 is calculated based on, for example, the integrated value of the current Ip1 flowing through the first positive line 31 when the series relay Rs is in the ON state and the first parallel relay Rp1 and the second parallel relay Rp2 are in the OFF state. Here, the current Ip1 is a current flowing through the first battery 13 and the second battery 14. The open-circuit voltage OCV1, OCV2 is derived, for example, by applying the power storage ratio SOC1, SOC2 to a map determined in advance by experimentation, analysis, machine-learning, or the like as a relation between the power storage ratio SOC1, SOC2 and the open-circuit voltage OCV1, OCV2. The allowable input power Win1, Win2 is derived, for example, by applying the power storage ratio SOC1, SOC2 and the temperature Tb1, Tb2 to a map determined in advance by experimentation, analysis, machine learning, or the like as a relation between the power storage ratio SOC1, SOC2, the temperature Tb1, Tb2, and the allowable input power Win1, Win2.

The control signals to the first and second inverters 22 and 24 and the control signals to the relays are outputted from the system ECU 50. Examples of the relays include a series relay Rs, a first parallel relay Rp1, and a second parallel relay Rp2. The system ECU 50 can communicate with a stand electronic control unit (hereinafter, referred to as a “stand ECU”) 86 of the charging station 80.

The charging station 80 includes a stand connector 82, a power supply device 84, and a stand ECU (power supply control device) 86. The stand connector 82 is configured to be connectable to the charging connector 44 of the power supply system 10. The power supply device 84 is connected to an AC power source (external power supply) such as a household power source or a commercial power source, and is configured to be capable of converting AC power from the AC power source into DC power and adjusting output power (output voltage and output current) so as to be output to the stand connector 82 side. The stand ECU 86 comprises a microcomputer as well as the system ECU 50. The stand ECU 86 receives signals of various sensors. Examples of the various sensors include a voltage sensor (not shown) that detects an output voltage Vs of the power supply device 84, and a current sensor (not shown) that detects an output current Is of the power supply device 84. A control signal to the power supply device 84 is outputted from the stand ECU 86. The stand ECU 86 is capable of communicating with the system ECU 50 as described above. The charging station 80 may be a first voltage station in which the voltage of the supplied power is a first voltage Vs1 (e.g., 400 V). The charging station 80 may be a second voltage station in which the voltage of the supplied power is a second voltage Vs2 (e.g., 800 V) higher than the first voltage Vs1. Other examples of the voltage of the supplied power include a third voltage stand that can selectively set either the first voltage Vs1 or the second voltage Vs2.

In the power supply system 10 of the embodiment configured as described above, the series-relay Rs is turned on when the motor 20 is traveling as the traveling motor. At the same time, the first parallel relay Rp1 and the second parallel relay Rp2 are turned off. Thus, the first battery 13 and the second battery 14 are connected in series, and the motor 20 is driven by the first inverter 22 using electric power from the first battery 13 and the second battery 14.

Further, in the power supply system 10, when the charging connector 44 and the stand connector 82 of the charging station 80 are connected, the system ECU 50 selects parallel charging when the voltage of the supplied power of the charging station 80 is the first voltage Vs1. Further, at this time, the system ECU 50 selects the series charging when the voltage of the power supplied by the charging station 80 is the second voltage Vs2.

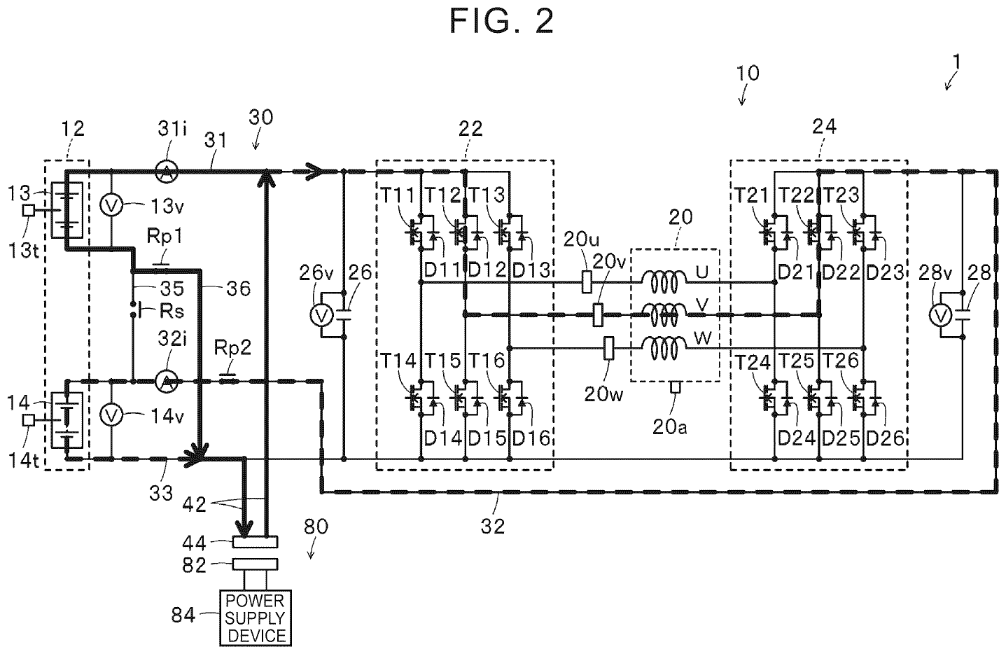

In the parallel charge, the series relay Rs is turned off and the first parallel relay Rp1 and the second parallel relay Rp2 are turned on. Thus, the first battery 13 and the second battery 14 are connected in parallel as viewed from the charging connector 44. Then, the first battery 13 and the second battery 14 are charged using the electric power from the charging station 80. FIG. 2 is an explanatory diagram illustrating a current flow during parallel charging. In the figure, a thick solid line with an arrow indicates a charging current of the first battery 13, and a thick broken line with an arrow indicates a charging current of the second battery 14. In parallel charging, the first battery 13 is charged by the current in the first charging path. As shown in the thick solid line with arrows in FIG. 2, the current of the first charging path flows from the charging connector 44 in the order of the positive line of the charging line 42, the first positive line 31, the first battery 13, the parallel line 36 (first parallel relay Rp1), the negative line 33, the negative line of the charging line 42, and the charging connector 44. The second battery 14 is charged by the current in the second charging path. The current of the second charging path, as shown in the thick broken line with arrows in FIG. 2, the positive line of the charging line 42 from the charging connector 44, the first positive line 31, the first inverter 22, the motor 20, the second inverter 24, the second positive line 32 (second parallel relay Rp2), the second battery 14, the negative line 33, the negative line of the charging line 42, the charging connector 44 flows in this order. At this time, the upper arm of the second inverter 24 is fixed on (the lower arm is fixed off). At the same time, the motor 20 and the first inverter 22 function as a three-phase step-down converter by executing a step-down control for duty-controlling the upper arm and the lower arm of the first inverter 22. Then, the input power of the first inverter 22 is stepped down and output from the motor 20. The upper arm of the first inverter 22 is turned on and fixed (the lower arm is turned off and fixed). At the same time, the motor 20 and the second inverter 24 function as a three-phase step-up converter by executing the step-up control for duty-controlling the upper arm and the lower arm of the second inverter 24. Then, the input power of the motor 20 is boosted and output from the second inverter 24.

In the series charge, the first battery 13 and the second battery 14 are connected in series by turning on the series relay Rs and turning off the first parallel relay Rp1 and the second parallel relay Rp2. Electric power from the charging station 80 is used to charge the first battery 13 and the second battery 14. In the series charging, the first battery 13 and the second battery 14 are charged by the current flowing from the charging connector 44 to the positive line of the charging line 42, the first positive line 31, the first battery 13, the series line 35 (series relay Rs), the second battery 14, the negative line 33, the negative line of the charging line 42, and the charging connector 44 in this order.

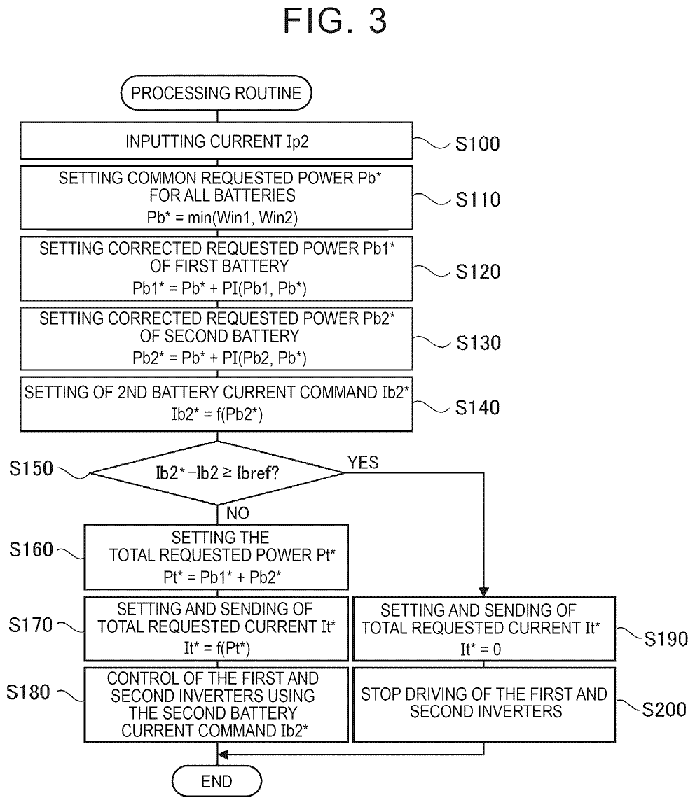

Next, the operation of the charging system 1 of the embodiment, in particular, the operation at the time of parallel charging in the power supply system 10 will be described. FIG. 3 is a flow chart illustrating a process routine executed by the system ECU 50. This routine is repeatedly executed during parallel charging. The series relay Rs is turned off and the first parallel relay Rp1 and the second parallel relay Rp2 are turned on prior to the repetition of the routine.

When this routine is executed, the system ECU 50 first performs a process of inputting a current Ip2 (S100). The current Ip2 is a current detected by the current sensor 32i. Next, the smallest value of allowable input power Win1, Win2 of the first and second batteries 13 and 14 is set to the common requested power Pb*, which is the common requested power of the first and second batteries 13 and 14 (S110). Subsequently, the system ECU 50 sets the corrected requested power (first corrected requested power) Pb1* of the first battery 13 by feedback correction for canceling the difference between the common requested power Pb* and the charging power Pb1 of the first battery 13 (S120). At the same time, the system ECU 50 sets the corrected requested power (the second corrected requested power) Pb2* of the second battery 14 by feedback correction for canceling the difference between the common requested power Pb* and the charging power Pb2 of the second battery 14 (S130). Here, the charging power Pb1 of the first and second batteries 13 and 14 is calculated by, for example, the product of the voltage Vb1 of the first and second batteries 13 and 14 and the current Ib1, Ib2 (the current Ip1, Ip2 flowing through the first and second positive lines 31 and 32).

Then, the system ECU 50 sets the current command Ib2* of the second battery 14 based on the corrected requested power Pb2* (S140). The system ECU 50 determines whether or not the difference between the current command Ib2* and the current S100 inputted current Ip2 (=Ib2*−Ip2), that is, the difference between the current command Ib2* and the charge current of the second battery 14 is equal to or greater than a predetermined Ibref (S150). The predetermined value Ibref is a threshold for determining whether or not the second charge path indicated by the thick broken line in FIG. 2 is interrupted. This, if the second charging path is not interrupted, S180 to be described later, the current Ip2 and the current command Ib2* becomes equal, while the difference between the current command Ib2* and the current Ip2 inputted by S100 is the value 0, when the second charging path is interrupted, the current Ip2 becomes the value 0, the difference between the current Ip2 and the current command Ib2* is based on a large. Therefore, S150 is a process of determining whether or not the second charge path is interrupted.

When the difference between the current command Ib2* and the current Ip2 is less than the predetermined value Ibref, the system ECU 50 determines that the second charging path is not interrupted, and the system ECU 50 sets the sum of the corrected requested power Pb1*, Pb2* of the first and second batteries 13 and 14 to the total requested power Pt* (S160). The system ECU 50 sets the total requested current It* based on the set total requested power Pt*, and transmits it to the stand ECU 86 of the charging station 80 (S170). The total requested current It* is calculated, for example, by dividing the total requested power Pt* by the output voltage Vs of the power supply device 84, or by dividing the total requested power Pt* by the largest value of the voltage Vb1, Vb2 of the first and second batteries 13 and 14. Upon receiving the total requested current It*, the stand ECU 86 controls the power supply device 84 so that a current corresponding to the total requested current It* is supplied from the charging station 80 to the power supply system 10. Then, the first and second inverters 22 and 24 are controlled based on the set current command Ib2* (S180), and the routine ends. The current command Ib2* is calculated, for example, by dividing the corrected requested power Pb2* by the voltage Vb2 of the second battery 14. By such a process, when the charging power Pb1, Pb2 of the first and second batteries 13 and 14 exceeds the common requested power Pb*, the corrected requested power Pb1*, Pb2* of the first and second batteries 13 and 14 becomes smaller than the common requested power Pb*. The common requested power Pb* is the smallest of the allowable input power Win1, Win2 of the first and second batteries 13 and 14. As a result, the total requested power Pt* becomes smaller than the power twice the common requested power Pb*, and the power from the charging station 80 becomes smaller. Therefore, it is suppressed that the charging power Pb1, Pb2 of the first and second batteries 13 and 14 continue to exceed the allowable input power Win1, Win2.

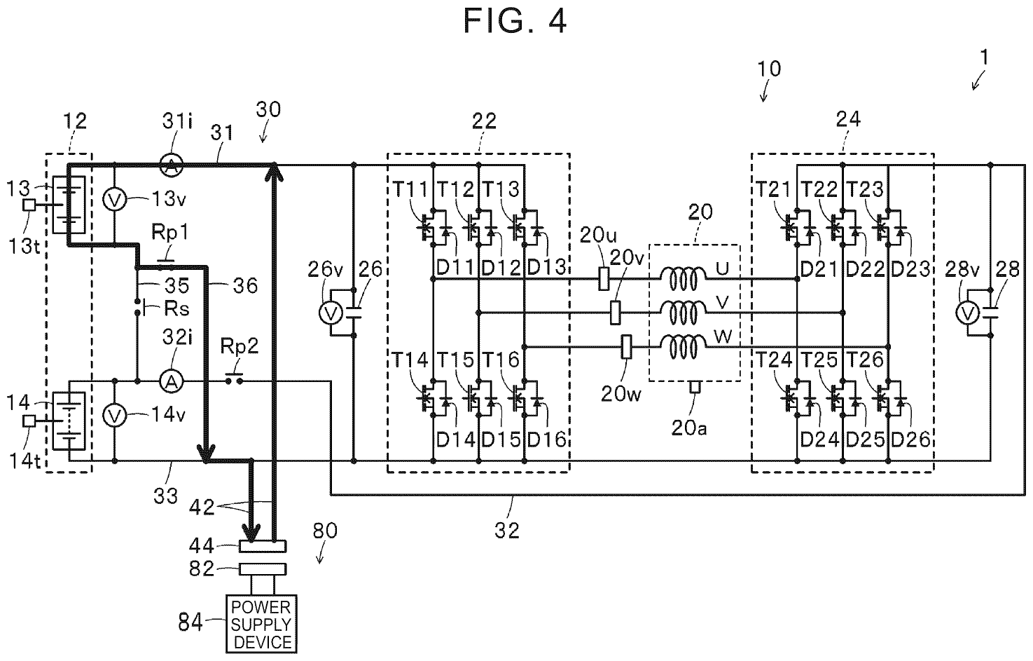

When the difference between the current command Ib2* and the current Ip2 is equal to or larger than the predetermined value Ibref, it is determined that the second charging path is interrupted, and the total requested current It* is set to the value 0 and transmitted to the stand ECU 86 of the charging station 80 (S190). Upon receiving the total requested current It*, the stand ECU 86 controls the power supply device 84 so that a current corresponding to the total requested current It* is supplied from the charging station 80 to the power supply system 10. Now, since the total requested current It* is set to 0, the stand ECU 86 controls the power supply device 84 so that the power supply from the charging station 80 to the power supply system 10 is stopped. Then, the first and second inverters 22 and 24 are stopped (S200), and the routine ends. The driving of the first and second inverters 22 and 24 is stopped by turning off all the gates of the transistors T11 to 16, T21 to T26 of the first and second inverters 22 and 24. By this process, the parallel charging is stopped. FIG. 4 is an explanatory diagram illustrating a current flow when a second charging path indicated by a thick broken line with an arrow in FIG. 2 is interrupted for some reason in parallel charging. In the drawing, a thick solid line with an arrow indicates a charging current supplied from the power supply device 84. When the second charging path is interrupted for some reason, the current concentrates on the first charging path indicated by the thick solid line with an arrow, and an overcurrent flows through the components of the first charging path, for example, the first parallel relaying Rp1. In the embodiment, since the parallel charging is stopped when the second charging path is interrupted, it is possible to prevent an overcurrent from flowing through the components of the first charging path.

According to the charging system 1 of the present embodiment described above, when the difference between the current command Ib2* and the current Ip2 of the second battery 14 is equal to or greater than the predetermined Ibref, a demand is transmitted to the charging station 80 so that the parallel charging is stopped. This prevents an overcurrent from flowing through the components of the first charging path.

Further, when the parallel charging is stopped, the parallel charging can be stopped more appropriately by setting the total requested current It* to 0.

Further, feedback correction based on differences between the common requested power Pb* and the charging power Pb1 of the first battery 13 is performed, and the corrected requested power Pb1* of the first battery 13 is set. At the same time, feedback correction is performed based on the difference between the common requested power Pb* and the charging power Pb2 of the second battery 14, and the corrected requested power Pb2* of the second battery 14 is set. When the sum of the corrected requested power Pb1* and the corrected requested power Pb2* is set to the total requested power Pt*, the total requested power Pt* is set more appropriately.

In the above-described embodiment, when the difference between the current command Ib2* and the current Ip2 of the second battery 14 is equal to or larger than the predetermined value Ibref, the total requested current It* is set to the value 0 and transmitted to the stand ECU 86 of the charging station 80. However, the total requested power Pt* may be set to 0, and the total requested current It* may be set based on the set total requested power Pt* and transmitted to the stand ECU 86 of the charging station 80.

In the above-described embodiment, feedback correction is performed based on differences between the common requested power Pb* and the charging power Pb1 of the first battery 13, and the corrected requested power Pb1* of the first battery 13 is set. At the same time, feedback correction is performed based on the difference between the common requested power Pb* and the charging power Pb2 of the second battery 14, and the corrected requested power Pb2* of the second battery 14 is set. The sum of the corrected requested power Pb1* and the corrected requested power Pb2* is set to the total requested power Pt*. However, twice the common requested power Pb* may be set to the total requested power Pt*. Thus, the total requested power Pt* can be set more appropriately.

The correspondence between the main elements of the embodiments and the main elements of the disclosure described in the column of the means for solving the problem will be described. In the embodiment, the first battery 13 corresponds to the “first battery” and the second battery 14 corresponds to the “second battery”. The motor 20 corresponds to a “motor”, the first inverter 22 corresponds to a “first inverter”, and the second inverter 24 corresponds to a “second inverter”. The charging connector 44 corresponds to a “charging connector”, and the system ECU 50 corresponds to a “control device”. Further, the series line 35 corresponds to the “series line”, and the series relay Rs corresponds to the “series relay”. The parallel line 36 corresponds to a “parallel line”, the first parallel relay Rp1 corresponds to a “first parallel relay”, and the second parallel relay Rp2 corresponds to a “second parallel relay”.

Note that the correspondence between the main elements of the embodiment and the main elements of the disclosure described in the section of the means for solving the problem is an example for specifically explaining the embodiment of the disclosure described in the section of the means for solving the problem, and therefore the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Although the embodiments for carrying out the present disclosure have been described above, the present disclosure is not limited to such embodiments at all, and it is needless to say that the present disclosure can be carried out in various forms without departing from the gist of the present disclosure.

The present disclosure is applicable to a manufacturing industry of a power supply system and a charging system.

What is claimed is:

1. A power supply system including a first battery and a second battery, the power supply system comprising:
a motor including a three-phase coil;
a first inverter connected to the first battery via a first positive line and a negative line and connected to one end of the three-phase coil;
a second inverter connected to the second battery via a second positive line and the negative line and connected to the other end of the three-phase coil;
a charging connector connected to the first positive line and the negative line and electrically connectable to charging equipment; and
a control device configured to, during parallel charging for charging the first battery and the second battery using electric power from the charging equipment, set a minimum value of each of first allowable input power of the first battery and second allowable input power of the second battery as common requested power of the first battery and the second battery, set total requested power based on the common requested power, request the charging equipment for the total requested power or a total requested current that is based on the total requested power, and control the first inverter and the second inverter using the common requested power or a current command for the second battery that is based on the common requested power, wherein
the control device is configured to request the charging equipment to stop the parallel charging when a difference between the common requested power and charging power of the second battery or a difference between the current command for the second battery and a charging current of the second battery is equal to or larger than a predetermined value.

2. The power supply system according to claim 1, wherein the control device is configured to, when stopping the parallel charging, set the total requested power or the total requested current to a value of zero.

3. The power supply system according to claim 1, wherein the control device is configured to set first corrected requested power of the first battery by performing feedback correction based on a difference between the common requested power and charging power of the first battery, set second corrected requested power of the second battery by performing feedback correction based on the difference between the common requested power and the charging power of the second battery, and set a sum of the first corrected requested power and the second corrected requested power as the total requested power.

4. The power supply system according to claim 1, wherein the control device is configured to set a double of the common requested power as the total requested power.

5. A charging system comprising:
the power supply system according to claim 1; and
the charging equipment, wherein
the charging equipment includes a power supply device configured to supply electric power from an external power supply to the power supply system, and a power supply control device configured to control the power supply device to supply the total requested power or the total requested current to the power supply system.
